(19) United States
(12) Patent Application Publication
(10) Pub. No.: US 2004/0129803 A1
(43) Pub. Date: Jul. 8, 2004

(54) Triggering means for a pressure jet injector

(76) Inventors: Monika Dolder, Ranflueh (CH); Frank Schiffmann, Burgdorf (CH)

Correspondence Address: David E. Bruhn, DORSEY & WHITNEY LLP, Intellectual Property Department, 50 South Sixth Street, Suite 1500, Minneapolis, MN, 55402-1498, US

(21) Appl. No.: 10/739,799

(22) Filed: Dec. 18, 2003

Related U.S. Application Data
(63) Continuation of application No. PCT/CH02/00313, filed on Jun. 12, 2002.

(30) Foreign Application Priority Data
Jun. 20, 2001 (DE) 10129584.7

(51) Int. Cl. B05B 7/02

(52) U.S. Cl. 239/525; 239/526; 239/527

(57) ABSTRACT

A pressure jet injector for administering an injectable product, including a casing, a pressure chamber connected to the casing, and a feeder for administering the product from the pressure chamber. To administer the product, a jet outlet, which may be formed as the pressure chamber outlet, is pressed against tissue using a pressing force. The pressing force acts on a trigger for the injector. The trigger is connected to the casing such that the pressing force is transferred to a resistance element. The resistance element is supported on the casing and the pressing force acting on the trigger is further transferred from the trigger onto the casing via the resistance element. The feeder is triggered as the pressing force reaches or exceeds a pre-set and/or measured magnitude.

### CROSS-REFERENCE TO RELATED APPLICATION(S)

This application is a continuation of International Application No. PCT/CH02/00313, filed on Jun. 12, 2002, which claims priority to German Application No. 10129584.7, filed on Jun. 20, 2001, the contents of both are incorporated herein by reference.

### BACKGROUND

The invention relates to a pressure jet injector for administering an injectable product. The product is preferably administered to the human body, however the invention can also be used in administering to animals or in any other application wherein a product is dispensed in the form of a product jet. The product jet exhibits a sufficiently strong impulse to penetrate a tissue surface and penetrate into the tissue to a desired depth. When injecting humans, for example, the impulse is large enough that the jet penetrates into human skin or, depending on the application, completely penetrates the skin. Growth hormones and insulin are examples of injectable products that may be administered using the present invention.

Due to the necessarily strong impulse of the product jet, there is a potential for safety concerns in handling pressure injectors. Unintentionally expelling the product into the environment represents a safety risk for a user him/herself and also for surrounding persons. Another problem is so-called wet administering, wherein the jet is directed onto the tissue surface from a distance.

### SUMMARY

The pressure jet injector of the present invention is safe to handle and generally prevents wet administering.

In one embodiment, a pressure jet injector in accordance with the present invention comprises a casing, a feeder, a pressure chamber, a trigger for triggering the feeder and at least one resistance element assigned to or operably coupled to the trigger. The feeder is mounted to the casing, attached in or on the casing such that it can perform its feeding action. The product is administered from the pressure chamber by the feeding action of the feeder. The product is expelled as a product jet through a jet outlet of the device. The jet outlet may be a direct outlet of the pressure chamber, but may also be connected to a pressure chamber outlet via a connecting conduit or conduit system. The jet outlet forms a front end of the device. The pressure chamber may be formed integrally with the casing. In one embodiment, preferably, however, the pressure chamber is separate from and connected to the casing. The pressure chamber may form a part of the trigger. When triggering the feeder, the trigger acts on a resistance element which is supported on the casing.

The pressure jet injector can be used for needle-free injections and for needle-free infusions. An injection needle is not required as an infusing part. However, use of a needle is not ruled out by the present invention. The jet outlet, for instance, may be formed as a needle.

For administering, the jet outlet is pressed, using a pressing force, against tissue into which the product is to be administered. The trigger is connected to the casing such that the pressing force is applied to the resistance element by the trigger. Because the resistance element is supported on the casing, the force acting on the trigger for pressing the device is transferred from the trigger onto the casing via the resistance element. The trigger absorbs at least a portion of the pressing force. The feeder is triggered by the trigger after the pressing force reaches or exceeds a magnitude which is pre-set by the resistance element and/or measured by the resistance element.

The trigger may be configured as a slider connected to the casing such that it may be shifted against a resistance force produced substantially by the resistance element. The resistance element cooperates with the slider and acts as an elastic restoring element for the slider and may be formed as a mechanical spring element. It may also formed as a pneumatic spring or any other suitable configuration. The spring characteristics of the resistance element pre-set the pressing force with which the jet outlet of the device has to be pressed against the tissue to trigger product delivery. The feeder is triggered when the slider has been shifted, against the resistance force of the resistance element, into a triggering position relative to the casing.

The slider may be shifted relative to the casing, towards a front end of the device which forms the jet outlet, such that to trigger the feeder, a force has to be exerted on the slider in the direction of the pressing force, which is conversely absorbed again by the casing as a reaction force. The slider can form a grip of the device by which the user can hold the device when pressing it against the tissue.

Portions or components of the invention, for example, the casing and/or the pressure chamber, may be produced as separate or integral parts. If the front casing part is produced as a separate part from the rear and middle casing parts, and connected to the rear and middle casing parts such that the front casing part may be shifted relative thereto and counter to the pressing force, then the front casing part may form the slider. In such embodiments, the resistance element is arranged between the middle and rear casing parts and the front casing part, and during pressing the front casing part is shifted relative to the rear and middle casing parts and against the resistance force of the resistance element. It is also possible to combine a front casing part which can be moved relative to the rear and middle casing parts and counter to the pressing force with another slider which can be moved relative to the rear and middle casing parts in the direction of the pressing force. In this embodiment, the resistance force of a resistance element arranged between the front casing part and the rear and middle casing parts and the resistance force of another resistance element arranged between the other slider and the rear and middle casing parts must be overcome to trigger the feeder.

The feeder can be triggered by any suitable switching mechanisms, for example mechanical switching mechanisms, electric or electronic mechanisms, or magnetic or optical switches. If an electric or electronic switch, such a piezo-electric resistance element, is used, the pressing force acts on the resistance element and the voltage thus generated in the resistance element triggers the feeder via a suitable switching mechanism. To ensure that the product jet is only expelled once a desired pressing force has been reached, the switching mechanisms triggers the feeder after a particular, pre-set piezo-electric voltage has been reached or when the selected voltage has been reached.

In some embodiments, a mechanical trigger is generally preferred to an electromechanical, magnetomechanical or optomechanical trigger. Using a mechanical trigger, the slider cooperates with a locking element which engages with the feeder in a positive or positive and frictional lock and through that engagement prevents a feeding action. Shifting the slider into the triggering position releases the engagement of the locking element and thus releases the feeder to start the feeding action.

The feeder forms a pump driven by a stored drive energy which can be released within a short period of time. The drive energy can be stored chemically and released by an appropriate chemical reaction. In some preferred embodiments, however, the drive energy is stored mechanically, for example in the form of a pressurized gas or in the form of mechanical spring energy. In the triggering position, the trigger triggers the release of the stored drive energy.

A suitable pump for the feeder is a piston pump having at least one piston accommodated in the pressure chamber such that it may be shifted towards the pressure chamber outlet. A drive element mounted by the casing such that it can be moved towards the pressure chamber outlet presses, directly or via a piston rod, against the piston in the manner of a piston rod. The released drive energy acts directly on the drive element. The stored drive energy acts on the drive element, although the locking element of the trigger is in locking engagement with the drive element, such that the drive element is prevented from moving by the engagement.

Optionally, a further switching process may be required to increase the safety of handling the device. For example, a further movement in addition to pressing the injector against tissue may be required to trigger the feeder. Thus, the feeder is only triggered once the additional switching process has occurred.

### BRIEF DESCRIPTION OF THE DRAWINGS

The invention will now be explained by way of exemplary embodiments, which are shown in the figures.

FIG. 1 is a perspective view of a first embodiment of a device in accordance with the invention, in a longitudinal section;

FIG. 2 is a perspective view of a front portion of a second embodiment of a device in accordance with the invention, in a longitudinal section;

FIG. 3 is a perspective view of a front portion of a third embodiment of a device in accordance with the invention, in a longitudinal section;

FIG. 4 is a perspective view of a front portion of a fourth embodiment of a device in accordance with the invention, in a longitudinal section; and

FIG. 5 is a perspective view of a front portion of another embodiment of a device in accordance with the invention, in a longitudinal section.

### DETAILED DESCRIPTION

Each of the figures show pressure jet injectors for administering an injectable product. The longitudinal sections include the central longitudinal axis of the respective injectors.

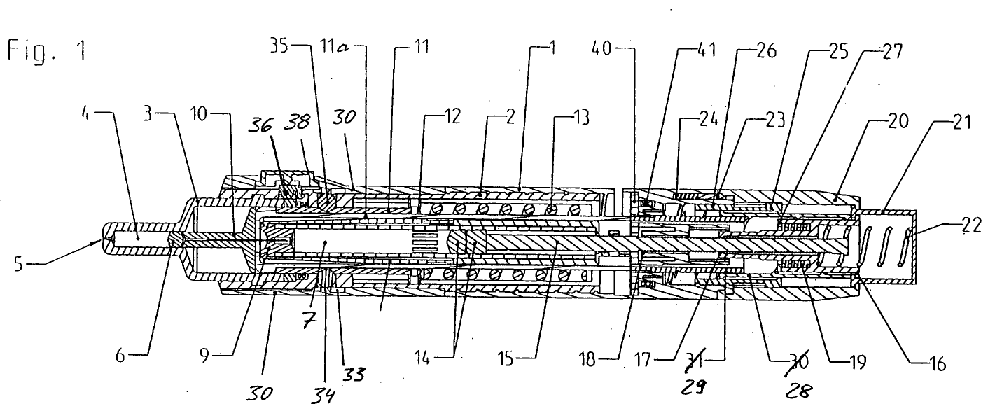

Only the embodiment of FIG. 1 is described in all its functions. In the case of the other embodiments shown, the respective triggers are shown and described in more detail, while reference is made to the description of the embodiment of FIG. 1 with respect to the other functional parts of the device.

The injector shown in FIG. 1 comprises a three-part casing including a rear casing part 1, a middle casing part 2 and a front casing part 3. The rear, middle and front casing parts 1, 2 and 3 are sleeve-shaped. The middle casing part 2 is screwed (or otherwise suitably connected to) into the rear casing part 1 and protrudes beyond a front end of the rear casing part 1. The front casing part 3 is detachably connected to the middle casing part 2 in a positive lock and protrudes beyond a front end of the middle casing part 2. The front casing part 3 forms, at a front end, a pressure chamber 4, or dosage reservoir, having a jet outlet 5 at its foremost free end. From the pressure chamber 4, a product dosage situated therein is delivered at high pressure through the pressure chamber outlet 5. During delivery, the conditions in the pressure chamber 4 and the pressure chamber outlet 5 are such that a directed product jet is expelled through the pressure chamber outlet 5 at a sufficiently high pressure for the product jet to enter a tissue at an injection point to a desired depth, for the purpose of injection, and upon reaching the desired depth of penetration to be distributed laterally. As shown, the jet outlet 5 is a pressure chamber outlet. Alternately, the jet outlet may be connected to the pressure chamber outlet via a connecting conduit.

The product dosage is delivered or expelled by a feeder, or piston, 6 accommodated in the pressure chamber 4 such that it may be linearly shifted towards the pressure chamber outlet 5. The expelling movement of the piston 6 is generated by an injection spring 13. Other types of drive for generating the expelling movement, for example gas pressure, may alternately be used. The injection spring 13 is positioned in an annular gap between the middle casing part 2 and a sleeve-shaped evacuating means 11a and is pressurized before an injection is triggered. It is then supported via its rear end on a collar of the middle casing part 2 protruding radially inwards and presses via its front end against a drive element 11 of a driver. The drive element 11 includes a flange 12, projecting radially outwards, at its rear end against which the injection spring 13 presses. The evacuating means 11a and the drive element 11 are accommodated in the middle casing part 2 such that they may be linearly shifted towards the pressure chamber outlet 5. The evacuating means 11a and the drive element 11 may be axially shifted relative not only to the casing but also to each other. As shown, the sleeve-shaped drive element 11 surrounds the evacuating means 11a concentrically. In a rear position, in which the injection spring 13 is tensed, the drive element 11 is secured against axially shifting towards the pressure chamber outlet 5.

A piston rod 10 arranged between the piston 6 and the evacuating means 11a transfers the translational movement of the evacuating means 11a onto the piston 6. The piston rod 10 includes a rear, plinth-like region which the evacuating means 11a presses against during its expelling movement, and a front region which protrudes from the plinth-like region towards the piston 6. The piston rod 10 presses against the piston 6 via its front free end. At least one connecting channel, through which the product may be fed, extends through the piston rod 10. A connecting needle is inserted in the at least one connecting channel, protruding backwards beyond the piston rod 10, and forming a fluid connection to a storage reservoir 7.

The storage reservoir 7 is formed by an ampoule which is accommodated within the rear and middle casing parts 1 and 2 by an ampoule holder 8. The ampoule holder 8 is sleeve-shaped and supported via its rear end on an unlocking element 40 inserted in the rear casing part 1. Holding elements protrude radially inwards from the middle casing part 2 through recesses in the evacuating means 11a which suitably fix the ampoule holder 8 in a positive and/or frictional lock. The ampoule 7 is inserted into the ampoule holder 8 up to a rear collar of the ampoule holder 8 protruding inwards. A membrane 9 seals the ampoule 7 imperviously to the front. The sleeve arrangement consisting of the ampoule 7 and the ampoule holder 8 is accommodated in the sleeve-shaped evacuating means 11a and presses via the front end of the ampoule holder 8 against a front collar of the evacuating means 11a protruding inwards, as soon as the device has been assembled. In this way, the ampoule holder 8 and the ampoule 7 are defined and held immovably relative to the rear and middle casing parts 1 and 2.

The ampoule 7 may be a twin-chamber ampoule. Alternately, a simple ampoule or other ampoule configuration may be used. While the ampoule 7 is stored, a powdery agent is provided in a front section of the ampoule 7. A liquid is provided in a rear section of the ampoule 7. Two pistons 14 are positioned in the ampoule such that they may be shifted towards the membrane 9. While the ampoule 7 is stored, the front piston 14 separates the liquid from the powdery agent, and the rear piston 14 seals off the section of the ampoule 7 filled with the liquid., the liquid being enclosed between the two pistons 14. To prepare the product for administering, the liquid and the powdery agent are mixed, by shifting the rear piston 14 towards the membrane 9. The incompressibility of the liquid causes the front piston 14 to be shifted together with the rear piston 14. This shift releases a division between the rear ampoule section and the front ampoule section. If the rear piston 14 is advanced further, the liquid from the rear ampoule section passes through the division into the front ampoule section and mixes with the powdery agent. Once the rear piston 14, in the course of this mixing movement, pushes against the front piston 14, the liquid is displaced from the rear ampoule section and the mixing process is complete. The injectable product, the agent and liquid mixture, is situated in the front ampoule section and can be displaced from the ampoule 7 by advancing the two pistons 14. The mixing process described is automatically performed when the device is assembled, i.e. when the rear and middle casing parts 1 and 2 are screwed together.

For administering, a selected product dosage is transferred from the ampoule 7 into the pressure chamber 4. In the embodiment shown the product dosage can be selected or set by a user. The product passes through the connecting needle and the connecting channel formed in the piston rod 10 to the front free end of the piston rod 10 opposite the rear side of the piston 6. Between the rear side of the piston 6 and the front free end of the piston rod 10, the product flows radially outwards and enters groove channels formed in the region of the inner surface area of the front casing part 3 which surrounds the piston 6 in its initial position before an injection, shown in FIG. 1. The groove channels lead past the piston 6 into the pressure chamber 4 and thus establish a connection between the connecting channel of the piston rod 10 and the pressure chamber 4.

The pressure chamber 4 receives a product dosage selected by the user, thus allowing doses of different sizes, a residual volume filled with air or another compressible gas is formed in the pressure chamber 4. The residual volume is formed after each transferring process, the size of the volume depending on the product dosage. Generally speaking, the larger the product dosage, the smaller the residual volume, and vice versa.

A dosing and activating means, comprising a dosing member 20 and an activating member 21 controls the selection of the product dosage to be transferred and administered. It also activates a dosing feeder, or transfer conveyor, comprising the front and rear pistons 14, for conveying the product dosage from the storage reservoir, or ampoule, 7 into the pressure chamber 4, and in cooperation with the evacuating means 11a evacuates the pressure chamber 4 after the transfer. The dosing and activating means 20, 21 is coupled to a control mechanism such that the control mechanism is positioned by a dosing movement of the dosing and activating means 20, 21. Thus, when the dosing and activating means 20, 21 is activated, transferring and evacuating are performed in a manner adjusted to one another.

The dosing member 20 is provided for performing the dosing movement. It is rotatably connected to the rear casing part 1, such that the dosing movement is a rotational movement. As shown, the dosing movement is a rotational movement about the central longitudinal axis of the device, which is identical to the movement axes of the pistons 6 and 14. The product is dosed in discrete increments in cooperation with a grid pin 23. The grid pin 23 is positioned in a cylindrical, axial hollow space, open to the rear, of the rear casing part 1 and is pressed against an axial facing area of the dosing member 20 by the influence of a pressure spring 24, likewise accommodated therein. Recesses are formed in the axial facing area of the dosing member 20, in accordance with the grid pitch, for receiving the grid pin 23.

The activating member 21 is connected to the dosing member 20 such that it can be shifted back and forth along the rotational axis of the dosing member 20. The activating member 21 protrudes backwards out of the sleeve-shaped dosing member 20. The activating member 21 is cup-shaped with a base at its rear end and a collar edge, the collar edge protruding radially inwards and radially outwards beyond the walls of the cup, at its front end.

The dosing member 20 engages with a sleeve-shaped stopper element 25. The engagement is such that a rotational movement of the stopper element 25 about the rotational axis of the dosing member 20 is prevented, but a translational movement of the stopper element 25 along the rotational axis of the dosing member 20 is possible. As shown, the translational movement of the stopper element 25 is a linear shift. The stopper element 25 is inserted into the dosing member 20 via its rear region and interlocks with blind grooves of the dosing member 20, forming a rotational block. A front region of the stopper element 25 forms a screw joint 26 with the rear casing part 1. Through these two couplings, with the dosing member 20 and with the rear casing part 1, the stopper element 25 can be moved along the rotational axis of the dosing member 20 into a stopper position. Thus, the stopper element 26 may be positioned, by the dosing movement of the dosing member 20 and in accordance with the extent of the dosing movement.

The control mechanism to which the dosing and activating means 20, 21 is coupled further comprises a sleeve-shaped slaving means 30. The slaving means 30 is coupled to the dosing member 20 in such a way that a rotational movement of the slaving means 30 about the rotational axis of the dosing member 20 is prevented, but a translational movement of the slaving means 30 along the rotational axis of the dosing member 20 is possible. As shown, the translational movement of the slaving means 30 is a linear shift. The dosing member 20 and the slaving means 30 are coupled via the stopper element 25, by the slaving means 30 protruding into the sleeve-shaped stopper element 25, forming the rotational block between the stopper element 25 and the slaving means 30, in a positive lock. A front section of the slaving means 30 comprises a screw thread on its inner surface area, the slaving means 30 thereby forming a screw joint 26 with the evacuating means 11a. The coupling between the slaving means 30 and the dosing member 20 and the evacuating means 11a is such that the slaving means 30 is moved along the movement axis of the evacuating means 11a, which, as shown, coincides with the rotational axis of the dosing member 20, into a stopper position. Thus, the slaving means 30 may be positioned, relative to the evacuating means 11a and the activating member 21 by the dosing movement of the dosing member 20.

As already mentioned, the dosing and activating means 20, 21 activate a dosing feeder, or transfer conveyor, for the storage reservoir. The feeding action of the feeder transfers the selected product dosage from the storage reservoir, or ampoule, 7 into the pressure chamber, or dosage reservoir, 4. The dosing feeder comprises the front and rear pistons 14, a piston rod 15 and a sleeve-shaped advancing element 16. The piston rod 15 protrudes into the ampoule 7 from behind. When activated, the piston rod 15 presses against the rear piston 14 and advances the rear piston 14 towards the membrane 9. The piston rod 15 is formed in a rear piston rod region. As shown, the piston rod 15 may be formed as a toothed rack having a serrated tooth profile. The advancing element 16 engages with the serrated tooth profile via engaging elements 17, such that when the advancing element 16 moves towards the membrane 9, the piston rod 15 is slaved and presses against the rear piston 14. The engagement of the engaging elements 17 prevents the piston rod 15 from being retracted relative to the advancing element 16. In order to also prevent the piston rod 15 from being retracted relative to the ampoule 7, the rear casing part 1 includes locking elements 18 which prevent such a relative movement by engaging with the serrated tooth profile of the piston rod 15. Other types of connection between an advancing element and a piston rod which are connected rigidly against shifting in the advancing direction may also be used. Further, the advancing element and piston rod may be formed as one piece.

In its stopper position, the stopper element 25 acts as a stopper for the advancing element 16. A collar 27 of the stopper element 25 protruding radially inwards at the rear end of the stopper element 25 forms the stopper for the advancing element 16 protruding into the slaving means 30. The slaving means 30 protrudes through the collar 27 of the stopper element 25. The nested arrangement of the dosing member 20, the stopper element 25 and the slaving means 30 reduces the axial length of the device. The axial length is also reduced by the control mechanism to which the dosing and activating means is couple dand the dosing member 20 surrounding the advancing element 16 and, at least before the product is first administered, the piston rod 15.

The activating member 21 acts on the advancing element 16 via a pressure spring 22. The pressure spring 22 is guided in a cylindrical hollow space of the advancing element 16, open towards the rear, and supported on a base of the hollow space and on the base of the activating member 21. Another elastic restoring element 19, also a pressure spring in the embodiment shown, is arranged between the advancing element 16 and the stopper element 25, such that it is tensed when the advancing element 16 is moved against the stopper element 25 or, more specifically, against the collar 27 of the stopper element 25.

Transferring the product dosage and evacuating the pressure chamber 4 are described in more detail in a parallel German patent application belonging to the Applicant, of the current date, entitled “Device for Administering an Injectable Product in Doses”. The teachings of that application are hereby incorporated by reference.

When the pressure chamber 4 has been filled with the product dosage, and, once filled, has been evacuated, administering can be triggered by activating a trigger. The trigger comprises a slider 30 including a releasing element 38. The slider 30 is connected to the middle casing part 2 such that it can slide along the central longitudinal axis. The slider 30 can shift relative to the rear, middle, and front casing parts 1, 2 and 3, towards the pressure chamber outlet 5 of the pressure chamber 4. This triggering movement, however, is only possible when the releasing element 38 is pressed, removing a shifting block for the slider 30. When the releasing element 38 is in its pressed position, the slider 30 is advanced towards the pressure chamber outlet 5, into a triggering position. In FIG. 1, the slider 30 assumes a locking position in which it holds locking elements 35 in locking engagement with the drive element 11 via a clamp 34. The triggering movement moves the clamp 34 away from the locking elements 35. A yielding space 33 radially overlaps with the locking elements 35 when the slider 30 has reached its triggering position. When the slider 30 is in its triggering position, the locking elements 35 can yield radially outwards into the yielding space 33, which releases the locking engagement with the drive element 11. The locking elements 35, which may be formed as spheres, may alternately be formed by a single spring-elastic locking ring. If a number of locking elements 35 are formed, then it is also possible, instead of a single annular circumferential clamp 34, to provide a clamp 34 for each locking element 35. Similarly, instead of a single groove-shaped circumferential yielding space 33, separate yielding spaces 33 may be formed for each of the locking elements 35.

In the triggering position of the slider 30, the spring force of the injection spring 13 causes the drive element 11 to push against the evacuating means 11a, already advanced due to the evacuating movement and abutting the piston rod 10. The drive element 11 thus pushes against the evacuating means 11a and the piston rod 10 and advances both due to the spring force of the injection spring 13. At the moment of impact, the spring force and the kinetic energy of the moving injection spring 13 and of the already accelerated drive element 11 act on the piston rod 10. Due to this impacting and advancing force, the piston rod 10 shoots forwards and pushes the piston 6 forwards towards the pressure chamber outlet 5 at a high initial speed. This delivers the product dosage at high pressure, in particular at a high initial pressure which preferably decreases to a lower value in the course of the injection. More specifically, the product dosage is expelled as a product jet.

Once the product dosage has been administered, the front casing part 3 is detached from the middle casing part 2, and the evacuating means 11a is moved back again together with the drive element 11, against the force of the injection spring 13, to the initial position shown in FIG. 1. Because in this initial position, the recess formed on the drive element 11 comes to rest among the locking elements 35, the slider 30 can also be moved back again into its initial position shown in FIG. 1 due to the elastic restoring force of the resistance element 31. The device is then ready for selecting and administering another product dosage from the ampoule 7 which is not yet empty. To facilitate moving back, the clamp 34 is tapered radially inwards from the side of the yielding space 33. As shown, the clamp 34 slopes obliquely into the yielding space 33. However, the locking elements 35 may exhibit a rounded cross-section on their radially outer sides, and, thus, the round shape of the locking elements 35 alone enables them to be slid over, without forming the clamp 34 as tapered.

The injector may be reloaded, i.e., once emptied, the ampoule 7 forming the storage reservoir can be exchanged for a new ampoule 7. To exchange the ampoule 7, the rear and middle casing parts 1 and 2 are screwed apart and the evacuating means 11a is removed from the rear casing part 1. The ampoule holder 8 together with the old ampoule 7 is then removed from the back of the evacuating means 11a and the new ampoule 7 is inserted into the ampoule holder 8. Removing the evacuating means 11a releases the disc-shaped unlocking element 40 which rises from the rear casing part 1 due to the pressure of the restoring element(s) 41. In its raised position, the unlocking element 40 can be rotated relative to the rear casing part 1 about the movement axis of the piston rod 15. When rotated, the unlocking element 40 slaves the piston rod 15, such that the piston rod 15 disengages from its toothed engagement with the advancing element 16 and the locking elements 18. The piston rod 15 can then be retracted relative to the rear casing part 1, into the initial position shown in FIG. 1. In its rotated position, the unlocking element 40 cannot be pressed into its fitting shown in FIG. 1, against the rear casing part 1, but exhibits a defined distance from its fitting position. The distance is chosen such that it just corresponds to the stroke of the rear piston 14 for the mixing process to be performed when using twin-chamber ampoules 7.

After a new ampoule 7 has been inserted into the ampoule holder 8 and the ampoule holder 8 together with the new ampoule 7 has been inserted into the evacuating means 11a, the rear and middle casing parts 1 and 2 are screwed back together. The piston rod 15 is then situated in its initial position (FIG. 1). Because, in its rotated position, the unlocking element 40 exhibits the described, pre-set distance from an opposite base area of the rear casing part 1, the rear piston 14 is advanced by the pressing piston rod 15 when the rear and middle casing parts 1 and 2 are screwed together, and the liquid and the powdery agent are mixed together. Once a prescribed mixing period has been observed, the unlocking element 40 is rotated back, without the piston rod 15 which is already engaged in toothed engagement with the advancing element 16 and the locking elements 18. Once rotated back, the unlocking element 40 is moved back to its initial position shown, i.e. to its fitting position, against the restoring element or elements 41, for example by screwing the rear and middle casing parts 1 and 2 further together, up to the initial position shown in FIG. 1.

The front casing part 3, or a new casing part 3 if desired, is then fixedly connected to the middle casing part 2, in a positive lock. As this connection is established, the connecting needle attached to the piston rod 10 punctures the membrane 9, establishing the fluid connection between the pressure chamber 4 and the storage reservoir, or ampoule, 7. The device then takes up the initial position shown in FIG. 1.

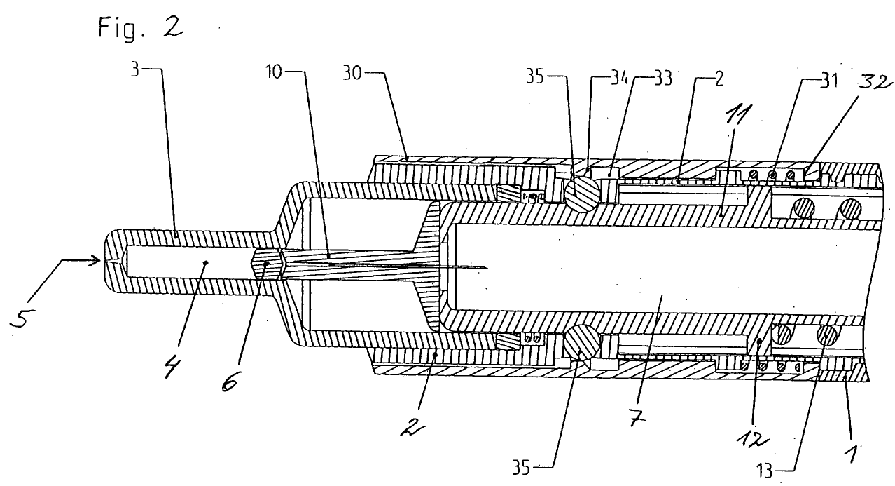

FIG. 2 shows a front portion of a pressure jet injector in accordance with a second embodiment of the present invention. The embodiment of FIG. 2 differs from the embodiment of FIG. 1 in having a modified trigger and in not having an evacuating function. The drive element 11 of FIG. 2 corresponds in shape to the evacuating means 11a and the drive element 11 of FIG. 1. However, the drive element 11 of FIG. 2 only performs the drive function of the drive element 11 of FIG. 2. Due to the omission of the evacuating function, the overall dosing and activating mechanism of the second embodiment is simpler than that of the first embodiment. The trigger is also designed more simply and a shifting block to be released for the slider 30 can be omitted.

To administer the product dosage, the injector is held against the tissue, for example human skin, via its foremost end, i.e., the pressure chamber outlet 5. To trigger the injection, the slider 30 is advanced relative to the rear and middle casing parts 1 and 2, against the force of an elastic resistance element 31. When pressing the device, the slider 30 forms a grip by which the device can be held and pressed against the tissue, as in FIG. 1.

To trigger the device, the device is pressed against the tissue with an application pressure, or pressing force, which may be pre-set, selected or adjusted by the resistance element 31. The slider 30 is arranged on the middle casing part 2 such that it can slide. As in FIG. 1, the slider 30 is formed as a sleeve body and surrounds a front section of the middle casing part 2. The resistance element 31 is arranged in an annular gap between the middle casing part 2 and the slider 30 and acts as a pressure spring between two collars axially facing each other, namely a collar 32 of the slider 30, protruding inwards, and a collar of the middle casing part 2, protruding outwards. The collar 32 of the slider 30 faces the pressure chamber outlet 5, and the collar of the middle casing part 2 faces away from the pressure chamber outlet 5. When the slider 30 is shifted relative to the middle casing part 2, the resistance element 31 between the two collars approaching one another is pressurized axially.

In the initial position of the slider 30, the slider 30 holds each of a number of locking elements 35 in locking engagement with the drive element 11. The locking elements 35 are formed as spheres. Each of the locking elements 35 is tightly guided laterally into a radial bore of the middle casing part 2 such that, at least in the locking engagement, the locking elements 35 cannot yield with respect to the movement direction of the drive element 11. In the locking engagement, each of the locking elements 35 is accommodated via its radially inner region in a recess formed on the outer surface area of the drive element 11. The recess may be a circumferential groove or may be formed individually for each of the locking elements 35. As shown, the recess exhibits a round cross-section with each of the locking elements 35, at least in its portion accommodated in the recess, being correspondingly rounded in its cross-section. The recess or number of recesses and the locking elements 35 need not necessarily exhibit round cross-sectional shapes, however, it is desirable that the two cross-sectional shapes correspond. Thus, the locking elements 35 enable the drive element 11 to be shifted towards the pressure chamber outlet 5, when the locking elements 35 can yield radially outwards.

In the position of the slider 30 shown, the locking elements 35 are prevented from yielding radially outwards by the slider 30. As the embodiment of FIG. 1, the slider 30 forms the clamp 24 which forces the locking elements 35 radially inwards, into the recess. The clamp 34 is formed by a protrusion protruding radially inwards, such as a circumferential bulge, as one piece on the slider 30. A protrusion is not necessarily required to form the clamp 34, a smooth inner surface area region of the slider 30 could also form the clamp 34 for the locking element 35. Further, any suitable configuration for a clamp 34 for the locking element 35 may be used.

Axially alongside the clamp 34, behind the clamp 34 as viewed from the pressure chamber outlet 5, a space is provided into which the locking elements 35 can yield to release the locking engagement when the slider 30 is moved towards the pressure chamber outlet 5. As in FIG. 1, this yielding space 33 is formed by a recess formed as a simple annular groove on the inner surface area. Via a front collar area, the clamp 34 serves as a stopper for the shifting movement of the slider 30 towards the pressure chamber outlet 5. The middle casing part 2 is correspondingly provided with a reverse stopper collar facing the clamp 34.

When pressing the pressure chamber outlet 5 against the tissue, the slider 30 can be advanced against the force of the resistance element 31. The locking elements 35 are thus released from the clamp 34 and can yield radially outwards into the yielding space 33 formed directly behind the clamp 34. When the clamp 34 abuts the middle casing part 2, the triggering position of the slider 30 is reached, in which the yielding space 33 comes to rest radially over the locking element 35. The locking elements 35 are forced radially outwards, out of locking engagement because of the yielding space 33 and the load of the drive element 11.

When the slider 30 is in its triggering position, the spring force of the injection pin causes the drive element 11 to push forwards towards the pressure chamber outlet 5.

With respect to guiding back to the initial position and exchanging the ampoule, the teachings of FIG. 1 may be followed.

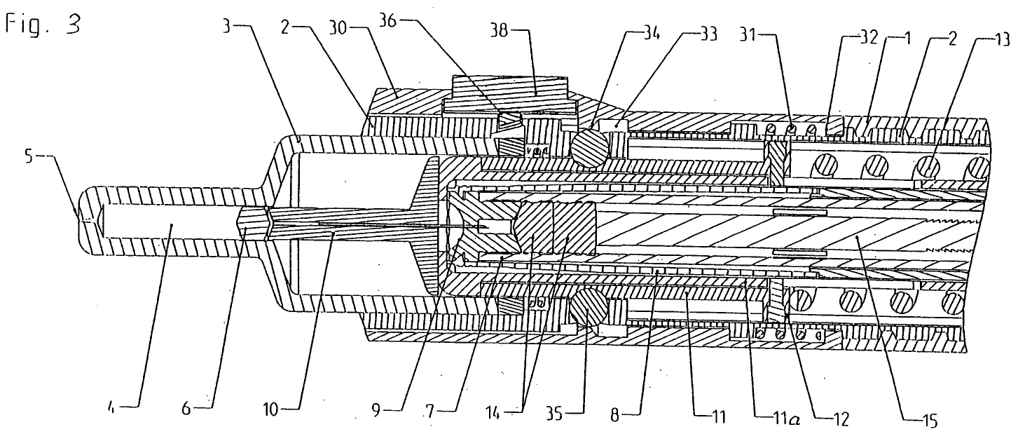

FIG. 3 shows a pressure injector having a third embodiment of a trigger. Except for the trigger, the pressure injector of FIG. 3 corresponds to the pressure injector of FIG. 1, such that reference is made to the description regarding FIG. 1.

In the trigger of the pressure injector of FIG. 3 a releasing element 38 is fastened to the slider 30 such that it can shift radially and functions as a triggering button. To trigger the injector, two movements must be performed to trigger the device. The releasing element 38 must be pressed radially inwards, and, once the releasing element 38 has been pressed, the slider 30 must be advanced relative to the front, middle and rear casing parts 1, 2 and 3, into a triggering position. If both movements are performed, the drive element 11 is released and, due to the pressure of the injection spring 13, pushes forwards towards the pressure chamber outlet 5. The triggering movement from the initial position to the triggering position is essentially as shown and described with reference to FIG. 2. The requirement of the separate releasing movement of the releasing element 38, that the releasing element 38 be pressed radially inwards, however, enhances protection against inadvertent delivery of the product.

The slider 30 is secured against unintentional triggering movements by a second locking element 36. The middle casing part 2 guides the second locking element 36 in the radial direction. The releasing element 38 acts radially inwards on the second locking element 36. In the secured position, in which the second locking element 36 locks the slider 30 against sliding forwards, the second locking element 36 partially protrudes into the guide formed by the middle casing part 2, and partially protrudes out of the middle casing part 2 and into a radial guide formed by the slider 30. An elastic restoring element presses the second locking element 36 into the secured position, as shown in FIG. 3. By pressing radially inwards onto the releasing element 38, the second locking element 36 is shifted relative to the middle casing part 2 until it no longer protrudes beyond the outer surface area of the middle casing part 2 facing the slider 30 and the releasing element 38. In this released position, the triggering movement of the slider 30 is no longer prevented by the second locking element 36.

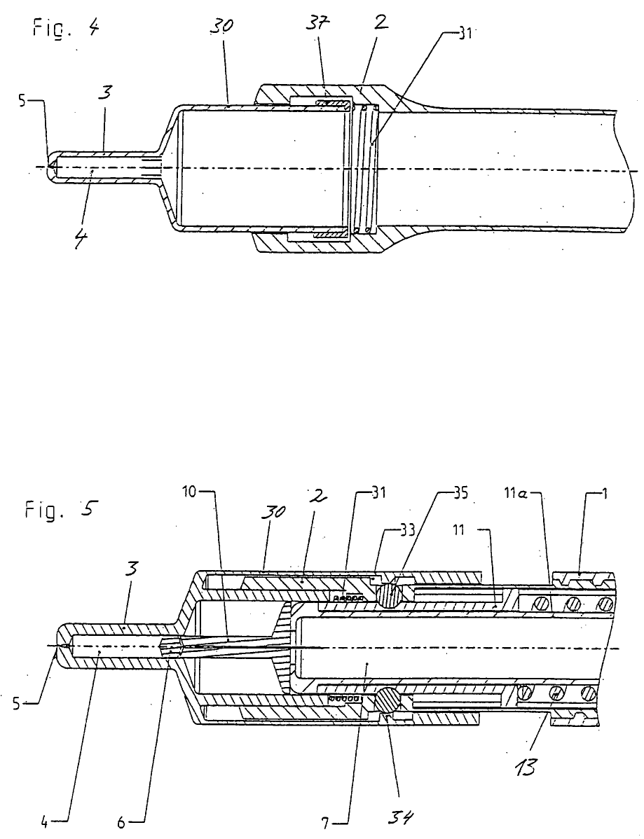

FIG. 4 shows a pressure jet injector having a trigger in accordance with a fourth embodiment of the present invention. Product delivery is triggered by a movement of the front casing part 3 relative to the middle casing part 2. The relative movement is performed against the resistance force of a resistance element 31. As shown, the resistance element is formed as a mechanical pressure spring. The resistance element 31 is accommodated in an annular gap surrounded by the middle casing part 2. The resistance element 31 is supported on a collar of the middle casing part 2 via its rear end and presses via a front end against the front casing part 3. The front casing part 3 is mounted with respect to the middle casing part 2 such that it can slide axially against the resistance force of the resistance element 31.

A stopper 37 for the front casing part 3 forming the slider 30 is formed by an annular element. The annular element is plugged onto the rear end of the slider 30 or front casing part 3, such that its front facing area and its rear facing area form the stopper against each of the facing stopper collars of the middle casing part 2. The reverse facing area of the annular element further forms the abutment for the resistance element 31. The slider 30 and the front casing part 3 can therefore be axially shifted jointly from the front stopper position, against the restoring force of the resistance element 31, as far as the triggering position shown in FIG. 4.

For injecting, the user grasps the middle casing part 2 and presses the pressure chamber outlet 5 against the skin at the injection point. The pressing force causes the front casing part 3 to be moved relative to the middle casing part 2, against the resistance force of the resistance element 31. This relative movement triggers the feeder, for example electrically or magnetically, via a trigger (not shown). For triggering, a switching element may be provided, so as not to trigger product delivery solely by reaching the triggering position.

FIG. 5 shows a fifth embodiment corresponding to the embodiment of FIG. 1 with respect to dosing and activating, in particular with respect to evacuating the pressure chamber 4 and delivering the product. The triggering mechanism of the embodiment of FIG. 5 is similar to the triggering mechanism of the embodiment of FIG. 4, in that the front casing part 3 also forms the slider 30. The triggering mechanism of the embodiment of FIG. 5 is similar to the triggering mechanism of the embodiment of FIG. 2 in that the slider 30 forms a clamp 34 and alongside it a yielding space 33 and cooperates with the locking elements 35 in the same way as the slider 30 of FIG. 2. The yielding space 33 of the fifth embodiment is arranged in front of the clamp 34 because the triggering movement of the slider 30 relative to the rear and middle casing parts 1 and 2 is directed towards the rear end of the injector. The triggering movement is performed against the elastic restoring force of a resistance element 31, which is formed by a mechanical spring and arranged as a pressure spring. The resistance element 31 is arranged in an annular gap between the drive element 11 and the middle casing part 2 and supported in the axial direction between the front casing part 3 forming the slider 30 and the middle casing part 2, such that it is pressurized during the triggering movement of the slider 30. The front position, or locking position, of the front casing part 3 shown in FIG. 5, is defined by a stopper against the middle casing part 2.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A pressure jet injector for administering an injectable product, said pressure jet injector comprising:
a) a casing;
b) a feeder mounted on the casing;
c) a pressure chamber from which the product is administered by a feeding action of the feeder, the product exiting through a jet outlet of the pressure jet injector;
d) a trigger for triggering the feeder; and
e) a resistance element supported by the casing, wherein a pressing force, with which the jet outlet is pressed against a tissue for an administration of the product, is exerted on the trigger and is transferred from the trigger to the resistance element and from the resistance element to the casing, the feeder being triggered as the pressing force reaches or exceeds a selected magnitude.

2. The pressure jet injector of claim 1, wherein the jet outlet is a pressure chamber outlet.

3. The pressure jet injector of claim 1, wherein the jet outlet is connected to a pressure chamber outlet via a conduit.

4. The pressure jet injector of claim 1, wherein the product exits the jet outlet as a jet stream.

5. The pressure jet injector of claim 1, wherein the trigger forms a grip for holding and pressing for the pressure jet injector.

6. The pressure jet injector of claim 1, wherein the magnitude of the pressing force necessary for triggering the feeder is pre-set.

7. The pressure jet injector of claim 1, wherein the magnitude of the pressing force necessary for triggering the feeder is measured by the resistance element.

8. The pressure jet injector of claim 1, wherein the trigger is configured as a slider connected to the casing such that it can be shifted against a resistance force of the resistance element.

9. The pressure jet injector of claim 8, wherein the resistance element cooperates with the slider and acts as an elastic restoring element for the slider.

10. The pressure jet injector of claim 9, wherein the resistance element is a mechanical spring.

11. The pressure jet injector of claim 10, wherein spring characteristics of the resistance element pre-set magnitude of the pressing force necessary for triggering the feeder.

12. The pressure jet injector of claim 8, wherein the slider can be shifted towards a front end of the pressure jet injector, the front end of the pressure jet injector forming the jet outlet.

13. The pressure jet injector of claim 8, wherein the slider forms a grip for holding and pressing the pressure jet injector.

14. The pressure jet injector of claim 8, wherein a front casing part of the casing forms the slider.

15. The pressure jet injector of claim 8, wherein the trigger includes a first locking element and, in a locking position, the slider holds the first locking element in engagement with the feeder, the engagement preventing the feeding action of the feeder until the engagement is released, the engagement being released by the slider shifting against the resistance force of the resistance element.

16. The pressure jet injector of claim 15, wherein the engagement between the locking element and the feeder is a positive lock.

17. The pressure jet injector of claim 15, wherein the slider includes a radial recess on a side facing the feeder, the recess being alongside the locking element, such that the locking element can yield into the recess to release the engagement with the feeder.

18. The pressure jet injector of claim 8, wherein in the locking position, the slider is secured by a second locking element such that the slider can only shift against the resistance force of the resistance element once it has been released, the slider being released by activating a releasing element which cooperates with the second locking element.

19. The pressure jet injector of claim 1, wherein the feeder includes piston and a drive element, the piston being accommodated in the pressure chamber such that it can be shifted towards the jet outlet and the drive element being mounted such that it can be shifted and upon which a drive force acts in the direction of the jet outlet, the drive force being triggered by the trigger.

20. The pressure jet injector of claim 19, wherein the trigger comprises a slider connected to the casing such that it can be shifted against a resistance force of the resistance element, the trigger including a first locking element such that, in a locking position, the slider holds the first locking element in engagement with the feeder, the engagement preventing the feeding action of the feeder until the engagement is released by the slider shifting against the resistance force of the resistance element, the first locking element being engaged with the drive element.

21. The pressure jet injector of claim 20, wherein in the locking position, the slider presses the first locking element radially against the drive element.

22. The pressure jet injector of claim 20, wherein the first locking element engages with a radial recess of the drive element.

23. A pressure jet injector for administering an injectable product, said pressure jet injector comprising:
a) a casing;
b) a pressure chamber connected to the casing from which the product is administered, the pressure chamber having a pressure chamber outlet at a front end;
c) a feeder for administering the product from the pressure chamber; and
d) a trigger for triggering the feeder to administer the product, wherein the pressure chamber outlet is pressed against a tissue with a pressing force, the pressing force being exerted upon the trigger and transferred to the casing via a resistance element, the feeder being triggered as the pressing force reaches or exceeds a selected magnitude.

24. The pressure jet injector of claim 23, wherein the trigger forms a grip for holding and pressing the pressure jet injector.

25. The pressure jet injector of claim 23, wherein the trigger is configured as a slider connected to the casing such that it can be shifted against a resistance force of the resistance element.

26. The pressure jet injector of claim 25, wherein the resistance element cooperates with the slider and acts as an elastic restoring element for the slider.

27. The pressure jet injector of claim 26, wherein the resistance element is a mechanical spring.

28. The pressure jet injector of claim 27, wherein spring characteristics of the resistance element pre-set magnitude of the pressing force necessary for triggering the feeder

29. The pressure jet injector of claim 25, wherein the slider can be shifted towards the pressure chamber outlet.

30. The pressure jet injector of claim 25, wherein the slider forms a grip for holding and pressing the pressure jet injector.

31. The pressure jet injector of claim 25, wherein the slider includes a releasing element and the slider can only be shifted once the releasing element is pressed.

32. The pressure jet injector of claim 20, wherein the casing comprises front, middle, and rear casing parts, the front casing part being connected to the rear and middle casing parts such that the front casing may be shifted relative to the rear and middle casing parts and counter to the pressing force.

33. The pressure jet injector of claim 32, wherein the trigger is configured as a slider connected to the casing such that it can be shifted against a resistance force of the resistance element.

34. The pressure jet injector of claim 32, wherein the front casing part forms the trigger.

35. The pressure jet injector of claim 32, wherein the feeder is a pump accommodated with in the front casing part
